(19) United States
(12) Patent Application Publication
(10) Pub. No.: US 2012/0188544 A1
(43) Pub. Date: Jul. 26, 2012

(54) STAND AND METHOD FOR COLOR MATCH EVALUATION

(75) Inventors: Katalin Friery, Saline, MI (US); Ankil Shah, Ann Arbor, MI (US)

(73) Assignee: Toyota Motor Engineering & Manufacturing North America, Inc., Erlanger, KY (US)

(21) Appl. No.: 13/014,377

(22) Filed: Jan. 26, 2011

(51) Int. Cl. G01J 3/46; G01N 21/01

(52) U.S. Cl. 356/402; 356/244

(57) ABSTRACT

The present invention provides an apparatus and method for consistently comparing at least two paint color panels. The apparatus includes a stand having a telescoping pole, a planar plate, at least one magnetic strip, and an angle measuring apparatus. The method of comparing at least two color samples includes the steps of affixing a first color sample to the planar plate, affixing the second color sample to planar plate, raising the planar plate to the eye level of the user, adjusting the planar plate to a first predetermined angle, visually comparing the first color sample to the second color sample, adjusting the planar plate to a second predetermined angle, visually comparing the first color sample to the second color sample, and repeating the steps of adjusting the planar plate to a predetermined angle and comparing the first color sample to the second color sample until testing is complete.

### FIELD OF THE INVENTION

This invention relates generally to color comparison testing. In particular, this invention relates to a method and apparatus for accurately comparing at least two painted panels.

### BACKGROUND OF THE INVENTION

When color standards are developed by a company, these painted panels are often provided to suppliers to match the paint sample. Once the paint supplier produces its own paint, the company frequently tests and compares the supplier test sample to the company developed control sample. Said color sample comparison is provided both visually and instrumentally. A spectrophotometer is used to instrumentally compare a paint sample color A to a paint-sample color B. Spectrophotometers also measure the amount of light absorption allowing to instrumentally compare color A to color B.

Visual comparison of color A to color B is conducted by a user visually inspecting and comparing color A to color B. The visual inspection of color A and color B may consist of comparing two color panels. The visual inspection of color A to color B is also conducted by having color A on a color panel and color B on a vehicle. The user compares the color A on the color panel to color B on the vehicle. The judgment is impacted by each individual, which contributes to inconsistencies in making a final color judgment. Eye deficiencies, distance, angles, and light conditions contribute to said inconsistencies making color comparison of color A to color B difficult. Accordingly, a method to visually compare at least two color paint samples having consistent distances, angles, and light conditions is highly desirable.

### SUMMARY OF THE INVENTION

The present invention provides an apparatus and method for consistently comparing at least two paint color panels. The apparatus includes a stand having a telescoping pole, a planar panel, at least one magnetic strip, and an angle measuring apparatus. The method of comparing at least two color samples includes the steps of affixing a first color sample to the panel stand, affixing the second color sample to the panel stand, raising the panel stand to the eye level of the user, adjusting the panel stand to a first predetermined angle, visually comparing the first color sample to the second color sample, adjusting the panel stand to a second predetermined angle, visually comparing the first color sample to the second color sample, and repeating the steps of adjusting the panel stand to a predetermined angle and comparing the first color sample to the second color sample until testing is complete.

### BRIEF DESCRIPTION OF THE DRAWINGS

FIG. 1 is a perspective view of the color sample comparison stand;

FIG. 2A shows a user viewing two color samples at a first predetermined angle;

FIG. 2B depicts a user viewing two color samples at a second predetermined angle;

FIG. 2C depicts a user viewing two color samples at a third predetermined angle; and

FIG. 3 shows the method in which a user strategically compares at least two color panels to one another.

### DETAILED DESCRIPTION OF THE PREFERRED EMBODIMENTS

The present invention provides for a standardized apparatus and method to accurately compare at least two color samples. The apparatus and method are used together to accurately allow a user to view and compare a plurality of paint color samples. The color samples are placed adjacent to one another on a plate of the stand, the stand is raised to a predetermined height, the plate is tilted to a predetermined angle, and the user then compares the two color samples to one another. The height of the plate is moved to a predetermined distance according to the eye level of the user. The user further stands a predetermined distance away from the plate. The testing method is repeated having the plate at several predetermined angles. The final judgment call regarding the color characteristic comparison of the color samples is ultimately made by the user.

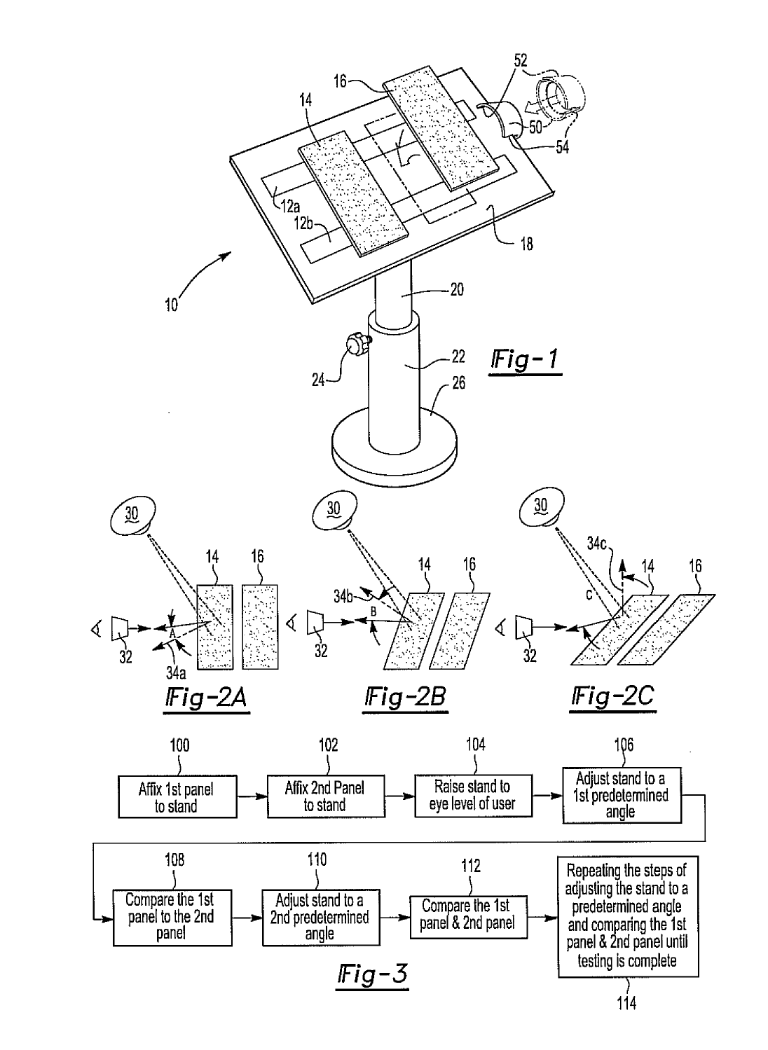

FIG. 1 shows the color match stand 10 used in connection with the accompanying method. The color match stand 10 includes a plate 18 and a base 26. A telescoping pole 20 rests within the housing 22 and is adjustable by means of the knob 24. The telescoping pole 20 and the plate 18 are raised to a predetermined height according to the user 32 eye level. The method is carried out when the plate 18 is at the eye level of the user 32. The plate 18 further includes magnetic strips 12a and 12b. In an alternative embodiment, the plate 18 is magnetic. In yet another alternative embodiment, various magnetic shapes are provided allowing color samples 14, 16 to adhere to the stand 18. The magnetic strips 12a, 12b allow for secure adhesion of the color samples 14, 16 to the stand 18. In an alternative embodiment, the color samples 14, 16 may be affixed to the plate 18 by means of glue, double-sided tape, or other adhesive means.

The plate 18 can be tilted at varying angles and the color samples 14, 16 will not fall off due to the magnets 12a, 12b. The base 26 is generally circular and broad to provide a stable base for the stand assembly 10. The base 26 may vary in configuration such as having a plurality of legs or a square base. The plate 18 is painted a neutral color such as gray. The neutral color of the plate 18 allows for the user 32 to more easily compare color panels 14, 16 without having the eye distracted by a bright background. The plate 18 is tiltable to allow the user 32 to view the color samples 14, 16 at varying predetermined angles.

Angle measuring device 50 is provided attached to the stand 18. Various angle measuring devices 50 may be used to determine an angle which the stand 18 should be fixed to form the predetermined angle. The DuPont™ AccuAngle™ is used to determine the reflective angle as viewed from the user 32. As shown in FIGS. 2A-2C, predetermined angles A, B and C are measured from the line of sight of the user 32 to the light reflecting 34a, 34b, 34c. Predetermined angle A is measured from the line of sight of the user 32 to the reflected light 34a. Predetermined angle B is measured from the line of sight from the user 32 to the reflected light 34b from the sun 30. Predetermined angle C is measured from the line of sight of the user 32 to the reflected light 34c from the sun 30 reflected off of the samples 14, 16. The predetermined angles A, B, C are incrementally measured and range between 5 degrees and 180 degrees. In the preferred embodiment, predetermined angles A, B, C, D and E as viewed by the user 32 reflecting from the sun 30 are measured at predetermined angles 15 degrees, 25 degrees, 45 degrees, 75 degrees and 110 degrees. Furthermore, said measurements are taken between 10:00 a.m. and 2:00 p.m. when the sun 32 is shining at the most intense level, preferably at 12 pm.

The user 32 is required to stand at a predetermined distance D away from the stand 10. The predetermined distance D ranges between 2 feet and 5 feet. The user 32 observes the color samples 14, 16 at a predetermined distance. The user 32 then moves to a second predetermined distance D2 and observes the color panels 14, 16. The user 32 may move to a predetermined distance several times before completing the testing procedure.

The method according to FIG. 3 comprises the steps of affixing 100 the first color sample 14 to the plate 18 and affixing 102 the second color sample 16 to the plate 18. In this embodiment, the first color sample 14 is the control sample and the second color sample 16 is the color panel being compared to the control color sample 14. The control color sample 14 remains the same throughout the testing procedure.

The second color sample 16 is switched for a different second panel to compare the color of the second color sample 16 or the different second color sample to the control first control color sample 14. The plate 18 is then raised 104 to the eye level of the user 32. The predetermined height at the eye level of the user 32 remains constant throughout the testing procedure until the user 32 is replaced with a different user 32. The user 32 is required to stand a predetermined distance D away from the stand 10. The predetermined distance D may vary throughout the course of the testing procedure. The panel 18 is adjusted to a first predetermined angle 106. The user 32 compares 108 the first panel 14 to the second color sample 16. The panel 18 is then adjusted to a second predetermined angle 110 and the user 32 compares 112 the first color sample 14 to the second color sample 16. This process is repeated 114 until testing is complete.

In this embodiment, the first predetermined angle is 15 degrees and the second predetermined angle is 25 degrees. The user 32 then repeats the steps of adjusting the plate 18 to a predetermined angle and comparing the first color sample 14 to the second color sample 16 until testing is complete.

This invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

We claim:

1. A method for comparing at least two paint color samples, the method utilizing a stand having a planar plate operable to tilt and extend telescopically, the method comprising the steps of:
affixing a first color sample to a plate;
affixing a second color panel to the plate;
raising the plate to the eye level of the user;
adjusting the plate to a first predetermined angle with respect to a horizontal plane;
visually comparing the first color sample to the second color sample;
adjusting the plate to a second predetermined angle; and
repeating the steps of adjusting the plate to a predetermined angle and comparing the first color sample to the second color sample until testing is complete when a tester determines that the first color sample matches or doesn't match the second color sample.

2. The method according to claim 1, wherein the plate is generally planar.

3. The method according to claim 1, wherein the first predetermined angle is 15 degrees.

4. The method according to claim 1, wherein the second predetermined angle is 25 degrees.

5. The method according to claim 1, wherein a third predetermined angle is 45 degrees.

6. The method according to claim 1, wherein a fourth predetermined angle is 75 degrees.

7. The method according to claim 1, wherein a fifth predetermined angle is 110 degrees.

8. The method according to claim 1, wherein the plate is painted a neutral color.

9. The method according to claim 8, wherein the neutral color of the plate is grey.

10. The method according to claim 1, wherein the color sample panel is affixed to the plate.

11. The method according to claim 10, wherein the color sample is affixed to the plate by magnetic means.

12. The method according to claim 10, wherein the color sample is affixed to the plate by an adhesive.

13. The method according to claim 1, wherein a user stands a predetermined distance away from the stand.

14. The method according to claim 1, wherein the predetermined distance ranges between two (2) and five (5) feet.

15. An apparatus for comparing color paint samples, the apparatus comprising:
a plate colored a predetermined neutral color, the planar stand having a means for affixing at least two color samples to the panel; and
a telescoping rod connected to the plate, the plate pivotally connected to the telescoping rod allowing for the plate to tilt to a predetermined angle.

16. The apparatus of claim 15, wherein the predetermined neutral color of the plate is grey.

17. The apparatus of claim 15, wherein the means for affixing the at least two color samples to the plate is magnetic.

18. The apparatus of claim 15, wherein the means for affixing the at least two color samples to the plate is adhesive.

19. The apparatus of claim 15, wherein an apparatus to measure angles is provided.
